(19) United States
(12) Patent Application Publication
(10) Pub. No.: US 2015/0266476 A1
(43) Pub. Date: Sep. 24, 2015

(54) COORDINATING ENGINE START/STOP WITH ADAPTIVE CRUISE CONTROL STOP-AND-GO

(71) Applicant: FORD GLOBAL TECHNOLOGIES, LLC, Dearborn, MI (US)

(72) Inventors: Sangeetha Sangameswaran, Canton, MI (US); Mathew A. Boesch, Plymouth, MI (US); Jeffrey A. Palic, Canton, MI (US); Aaron L. Mills, Ann Arbor, MI (US); Rebecca L. Seiler, Northville, MI (US)

(73) Assignee: FORD GLOBAL TECHNOLOGIES, LLC, Dearborn, MI (US)

(21) Appl. No.: 14/220,395

(22) Filed: Mar. 20, 2014

(51) Int. Cl. B60W 30/14; B60W 10/18; B60W 10/04

(52) U.S. Cl. CPC B60W 30/14; B60W 10/04; B60W 10/18

(57) ABSTRACT

An automotive vehicle includes engine start/stop (ESS) and adaptive cruise control with stop and go functionality (ACCS&G). A method of coordinating operation of the ESS and ACCS&G systems is provided. The ACCS&G system brings the vehicle to a stop. After a delay and satisfaction of autostop conditions, the ESS system stops the engine. Upon receipt of an input and satisfaction of start conditions, the ESS system restarts the engine. The ACCS&G system then resumes control of the restarted engine.

### BACKGROUND OF INVENTION

The present invention relates to a method of controlling an automotive engine and in particular to a method of coordinating an engine start/stop system with an adaptive cruise control stop-and-go system.

Automotive vehicle powertrains may incorporate an engine start/stop (ESS) system to improve fuel economy. The ESS system stops an internal combustion engine under specified conditions when engine torque is not required and restarts the engine when torque is again required. For example, the ESS system may stop the engine of a vehicle after a driver brakes the vehicle to a stop at a traffic light, with the vehicle transmission in drive, and then restart the engine when the driver requests torque by depressing an accelerator pedal.

Automotive vehicle powertrains may also incorporate an adaptive cruise control stop-and-go (ACCS&G) system. The ACCS&G system in a host vehicle monitors the position of a lead vehicle ahead of the host vehicle. The ACCS&G system will automatically adjust a speed of the host vehicle to maintain a specified distance (which may be a function of speed) between the host and lead vehicles. For example, the ACCS&G system in a host vehicle may command the host vehicle to stop when the lead vehicle has stopped and the specified distance (for that speed) between the host and lead vehicles can no longer be safely maintained.

However, because the ESS and ACCS&G systems both control operation of the powertrain, there is the possibility of conflicting commands. For example, for the vehicle having both ACCS&G and ESS systems, the ACCS&G system may make a torque request while the ESS system is executing an engine stop routine. This may occur when the host vehicle follows the lead vehicle to a stop, but almost immediately after the host vehicle has stopped, the lead vehicle resumes moving. Typically, the engine stop routine is completed before an engine start routine may be executed so that the vehicle may move. This may result in a delay before the torque request from the ACCS&G system is executed. The delay may be problematic when the torque request is a result of the lead vehicle moving. The host vehicle remains stationary until the ESS system has restarted the engine, and while the host vehicle is stationary, the lead vehicle moves further and further from the host vehicle. This delay may reduce the drivability of the host vehicle having both ESS and ACCS&G systems.

### SUMMARY OF INVENTION

An embodiment contemplates a method of controlling an engine. A first system brings a vehicle propelled by the engine to a stop while a second system is active. The second system, after a delay, stops the engine of the stationary vehicle upon detection of a status of the first system. The second system restarts the stopped engine upon receipt of an input. The first system resumes propelling the vehicle using the restarted engine.

Another embodiment contemplates a method of controlling an engine. A first system automatically brings a vehicle propelled by the engine to a stop while a second system is active. The second system, after a delay, stops the engine of the stationary vehicle upon detection of a status of the first system. The first system detects an input and the second system controls the engine per the input.

Another embodiment contemplates a method of controlling an engine. A driver of a vehicle activates a brake to bring the vehicle to a stop while a first system is deactivated and a second system is activated, the vehicle being propelled by the engine. The second system, after a delay, stops the engine while the vehicle is stationary and the first system remains deactivated. The driver activates the first system while the vehicle is stationary, the engine stopped, and the brake activated. The driver releases the brake while the first and second systems are activated and the engine stopped. The first system holds the vehicle stationary while the second system keeps the engine stopped.

An advantage of an embodiment is that the ESS and ACCS&G systems are coordinated. This will improve driveablity of the vehicle when the ACCS&G and ESS systems commands may conflict.

### BRIEF DESCRIPTION OF DRAWINGS

FIG. 1 is a schematic view of an automotive vehicle.

FIG. 2 is a flowchart for controlling an automotive powertrain.

FIG. 3a is a flowchart for controlling an automotive powertrain.

FIG. 3b is a flowchart for controlling an automotive powertrain.

FIG. 4 is a flowchart for controlling an automotive powertrain.

FIG. 5 is a flowchart for controlling an automotive powertrain.

### DETAILED DESCRIPTION

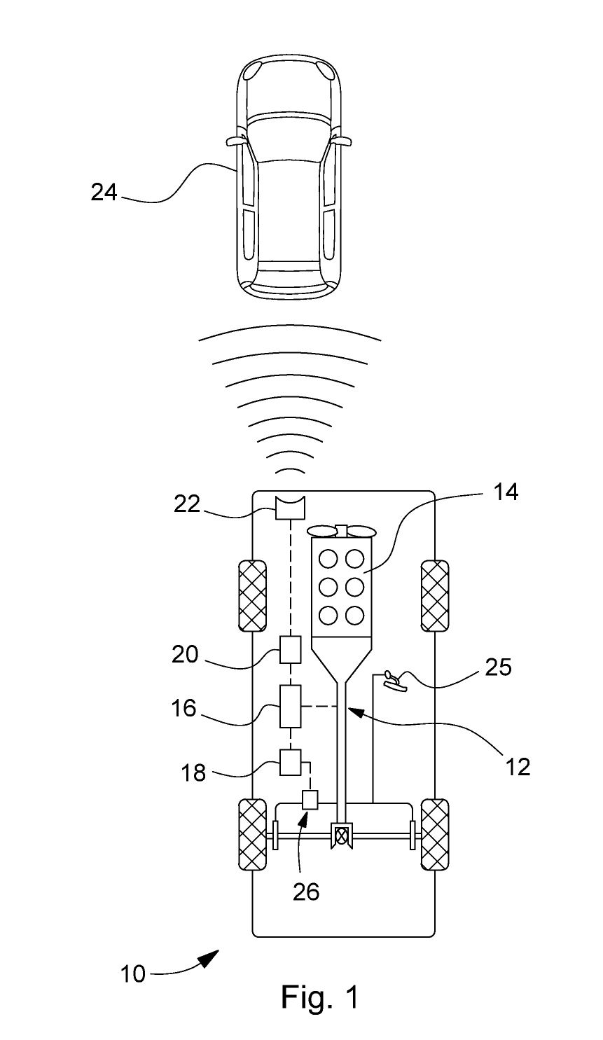

FIG. 1 schematically illustrates an automotive vehicle 10 having a powertrain 12. The powertrain 12 may be a typical automotive powertrain as understood by one skilled in the art. As illustrated, the powertrain 12 has an internal combustion engine 14. One skilled in the art will understand that the powertrain 12 may have the engine 14 only or the engine 14 in conjunction with an electric machine. Alternatively, the powertrain 12 may have an electrical machine in lieu of the engine 14. As illustrated, the powertrain 12 has a rear wheel drive configuration. One skilled in the art will understand that the powertrain 12 may have a front wheel drive or an all wheel drive configuration. Operation of the powertrain 12 is controlled by a powertrain controller 16.

The powertrain 12 includes an engine start/stop (ESS) controller 18. The ESS controller 18 coordinates a typical ESS system as understood by one skilled in the art. The ESS controller 18 may be separate from or integrated with the powertrain controller 16, and each may be made up of various combinations of hardware and software as is known to those skilled in the art. The term “system” as used herein means a mechanical and/or electrical assembly activated by a human to automatically carry out a procedure to a desired result. The ESS controller 18 monitors the vehicle 10 and, when predetermined conditions are present, signals the powertrain controller 16 to start or stop the engine 14. For example, the ESS controller 18 may detect that the vehicle 10 has been stationary for a predetermined period of time, in which case the ESS controller 18 will signal the powertrain controller 16 to execute an engine stop routine. For example, the ESS controller 18 may detect that the vehicle 10 is stationary, the engine 14 was stopped by the ESS system, and a torque request is being made, in which case the ESS controller 18 will signal the powertrain controller 16 to execute an engine start routine. For example, a driver of the vehicle 10 may press an accelerator pedal while the ESS system has stopped the engine 14. Pressing the accelerator pedal will make the ESS controller 18 signal the powertrain controller 16 to execute the engine start routine. The ESS system may be activated and deactivated by the driver, another system of the vehicle 10, or by the ESS controller 18 detecting a predetermined condition.

The powertrain 12 additionally includes an adaptive cruise control (ACC) controller 20. The ACC controller 20 may be separate from or integrated with the powertrain controller 16, and each may be made up of various combinations of hardware and software as is known to those skilled in the art. The ACC controller 20 coordinates a typical ACC system as understood by one skilled in the art. The ACC controller 20 uses a sensor 22 to detect a lead vehicle 24. The sensor 22 may be a radar-based sensor, a laser-based sensor, or another sensor type known to those skilled in the art. The sensor measures a lead distance from the vehicle 10 to the lead vehicle 24 and communicates with the ACC controller 20. The ACC controller 20 uses the lead distance, parameters of the vehicle 10 (such as a current speed of the vehicle 10), and preset limits to calculate whether to signal the powertrain controller 16 to increase or decrease torque produced by the powertrain 12 so that the lead distance may be maintained in accordance with a predetermined distance, which may be a function of vehicle speed. The ACC system may be activated and deactivated by the vehicle driver, another system of the vehicle 10, or by the ACC controller 20 detecting a predetermined condition. For example, the driver may deactivate the ACC system by pressing a “CANCEL” button or a brake pedal 25.

The ACC system includes stop-and-go functionality. Hereinafter, the term “ACCS&G” shall mean an ACC system that includes stop-and-go functionality. When the ACCS&G system is activated and the vehicle 10 is following the lead vehicle 24, if the vehicle 24 stops, the vehicle 10 will slow and stop behind the lead vehicle 24. While ACCS&G is slowing the vehicle 10 to a stop, the lead distance may be reduced less than the predetermined distance so that the vehicle 10 comes to a stop at a typical distance behind the lead vehicle 24. When the lead vehicle resumes moving, ACCS&G will start the vehicle 10 moving again. ACCS&G will accelerate the vehicle 10 such that the lead distance is restored to the predetermined distance.

The vehicle 10 includes a brake system 26 that is monitored by ESS controller 18. The brake system 26 is a typical automotive brake system as understood by one skilled in the art. As illustrated, the brake system 26 is schematic and shown only for rear wheels of the vehicle 10. As understood by one skilled in the art, the brake system 26 may also be used at other wheels of the vehicle 10.

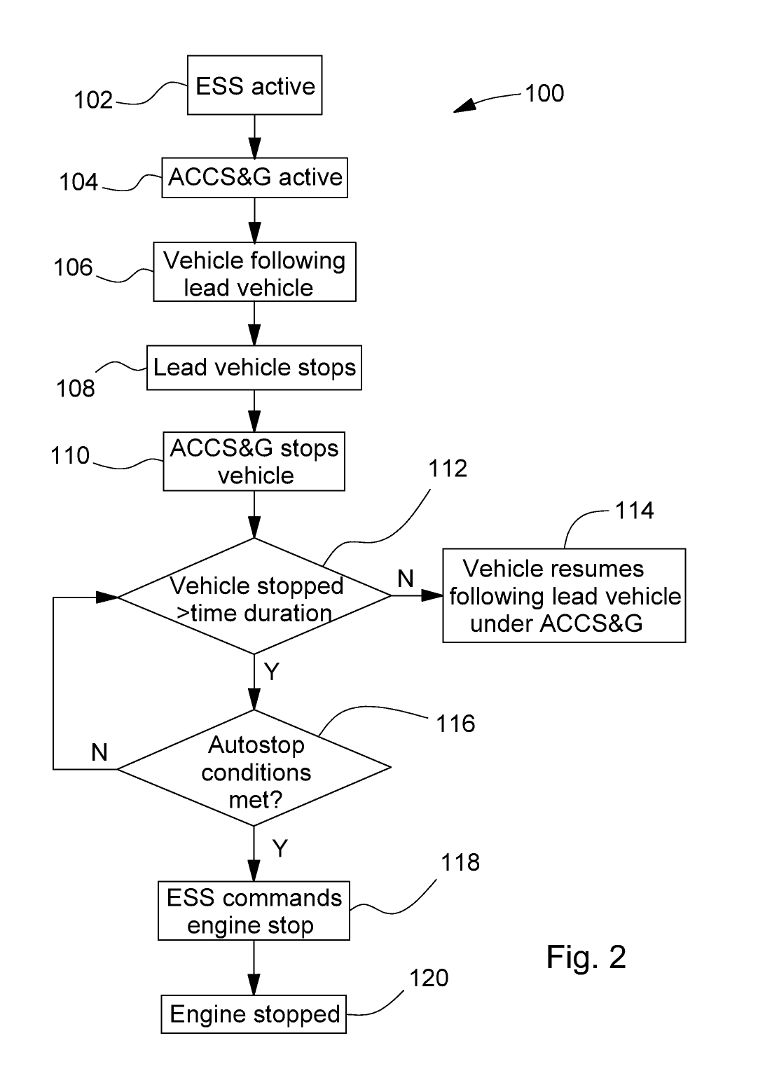

FIG. 2 will now be discussed with reference to FIG. 1. FIG. 2 is a flowchart illustrating a first coordinated operation 100 of the powertrain controller 16, the ESS controller 18, and the ACC controller 20 to stop the engine 14.

The ESS system is active in a step 102 and the ACCS&G system is active in a step 104. In a step 106, the vehicle 10, using the ACCS&G system, is following a lead vehicle 24. In a step 108, the lead vehicle has stopped and in a step 110, the vehicle 10, using the ACCS&G system, has slowed to a stop as well.

In a step 112, a time duration is measured starting when the ACCS&G system stops the vehicle 10 in the step 110. The time duration must exceed a minimum duration for the ESS system to command the engine 14 to stop. The minimum duration allows the vehicle 10 to quickly resume movement, for example, if the lead vehicle 24 makes only a brief stop for less than the minimum duration or the driver overrides the ACCS&G system by requesting acceleration. For example, the minimum duration may be 3 seconds.

If the lead vehicle 24 is not stopped for the minimum duration, then the ACC controller 20 directs the vehicle 10 to resume following the lead vehicle 24 in a step 114. If the lead vehicle 24 is stopped for at least the minimum duration, then the ACC controller 20 signals the ESS controller 18 and, in a step 116, the ESS controller 18 verifies if all autostop conditions have been satisfied. The autostop conditions include that the ACCS&G system is activated, not requesting acceleration, and is requesting braking to stop the vehicle 10 and that the vehicle 10 is being held stationary by the brake system 26. If the autostop conditions are not satisfied, then the step 112 is repeated. If the autostop conditions are satisfied, then in a step 118 the ESS controller 18 commands the powertrain controller 16 to stop the engine 14. In a step 120, the engine 14 has stopped.

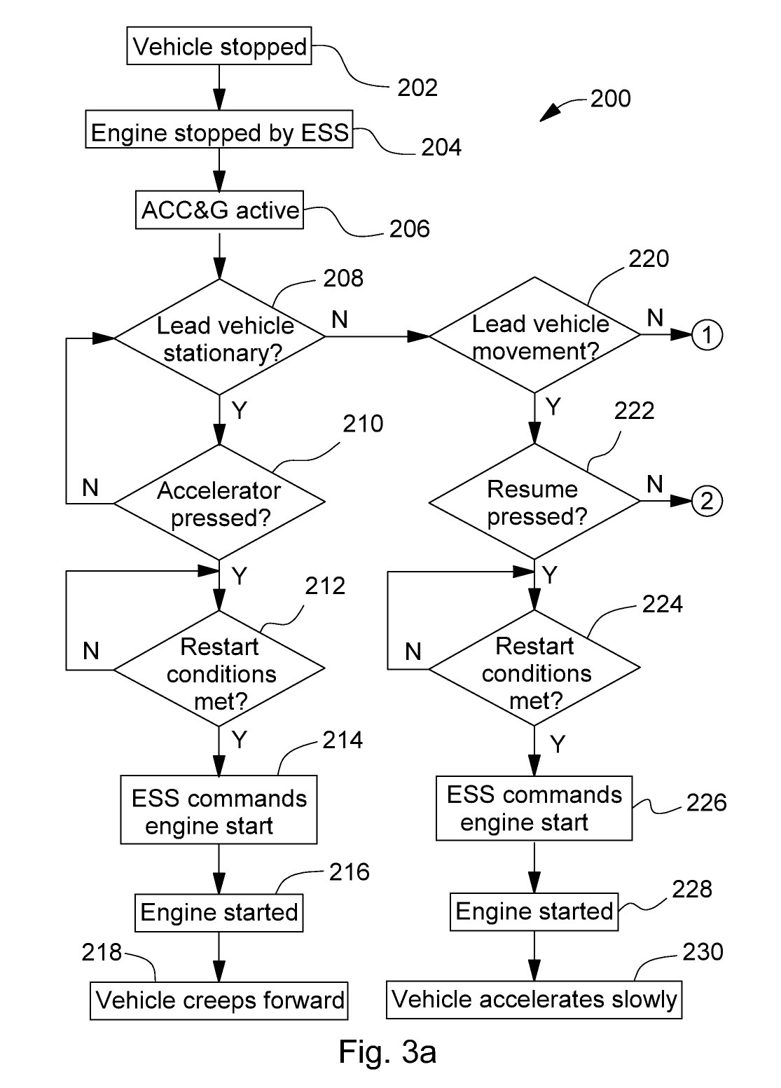

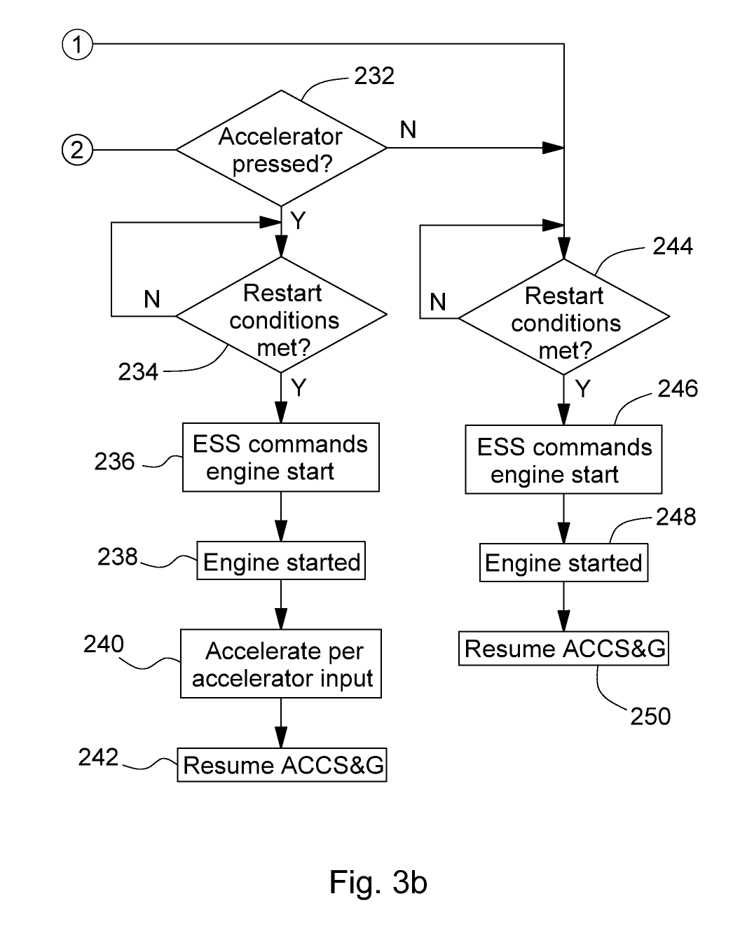

FIG. 3a and FIG. 3b will now be discussed with reference to FIG. 1. FIG. 3a and FIG. 3b are a flowchart illustrating a second coordinated operation 200 of the powertrain controller 16, the ESS controller 18, and the ACC controller 20 to start the engine 14. The second coordinated operation 200 may be used after the engine 14 has been stopped using the first coordinated operation 100.

In a step 202 the vehicle 10 is stopped, in a step 204 the ESS system has stopped the engine 14, and in a step 206 the ACCS&G system is active. In a step 208, the ACC controller 20 determines if the lead vehicle 24 is stationary. If the lead vehicle 24 is stationary, then in a step 210, the powertrain controller 16 determines if the accelerator pedal has been pressed.

If the accelerator pedal has been pressed, then, in a step 212, the ESS controller 18 determines if at least one restart condition has been satisfied. The restart conditions include the ACCS&G system requesting acceleration and not requesting braking to stop the vehicle 10, and the vehicle 10 not being held stationary by the brake system 26. If no restart condition has been met, then the step 212 is repeated. If at least one restart condition is satisfied, then in a step 214 the ESS controller 18 commands the powertrain controller 16 to start the engine 14. In a step 216 the engine 14 is started and in a step 218 the vehicle 10 creeps forward.

If the accelerator pedal has not been pressed, then the ACC controller 20 determines if the lead vehicle is still stationary in the step 208. If, in the step 208, the lead vehicle 24 is not stationary, then in a step 220 the ACC controller 20 will determine if the lead vehicle 24 has moved. If the vehicle has moved in the step 220, then, in a step 222, the ACC controller 20 determines if a “RESUME” button has been pressed by the driver.

If the “RESUME” button has been pressed in the step 222, then in a step 224 the ESS controller 18 will determine if at least one of the restart conditions has been met. If no restart condition has been met, then the step 224 is repeated. If at least one restart condition is satisfied, then in a step 226 the ESS controller 18 commands the powertrain controller 16 to start the engine 14. In a step 228 the engine 14 is started and in a step 230 the vehicle 10 accelerates slowly before the ACCS&G system resumes control of the powertrain 12.

If, in the step 222, the “RESUME” button has not been pressed, then in a step 232 the powertrain controller 16 determines if the accelerator pedal has been pressed. If the accelerator pedal has been pressed, then in a step 234 the ESS controller 18 will determine if at least one of the restart conditions has been met. If no restart condition has been met, then the step 234 is repeated. If at least one restart condition is satisfied, then in a step 236 the ESS controller 18 commands the powertrain controller 16 to start the engine 14. In a step 238 the engine 14 is started and in a step 240 the vehicle 10 accelerates in accordance with the accelerator press by the driver. Once the driver ends the accelerator press, then the ACCS&G system resumes control of the powertrain 12 in a step 242.

If, in the step 232, the accelerator pedal has not been pressed, then in a step 244 the ESS controller 18 will determine if at least one of the restart conditions has been met. If no restart condition has been met, then the step 244 is repeated. If at least one restart condition is satisfied, then, in a step 246, the ESS controller 18 commands the powertrain controller 16 to start the engine 14. In a step 248 the engine 14 is started and in a step 250 ACCS&G is resumed.

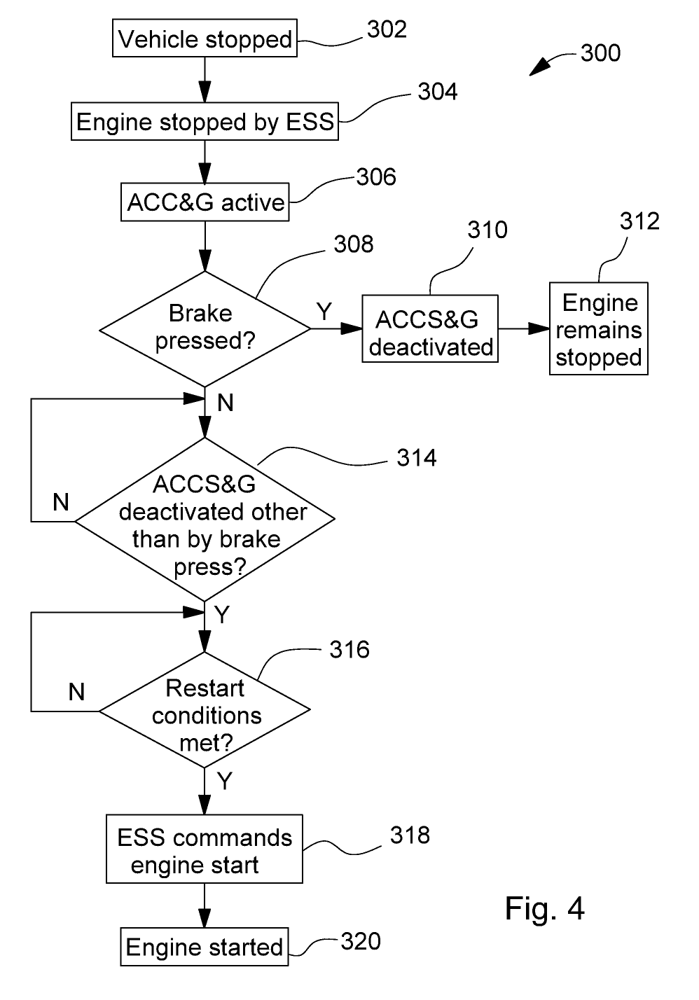

FIG. 4 will now be discussed with reference to FIG. 1. FIG. 4 is a flowchart illustrating a third coordinated operation 300 of the powertrain controller 16, the ESS controller 18, and the ACC controller 20 when the brake pedal 25 is pressed after the engine 14 has been stopped by the ESS system. The third coordinated operation 300 may be used after the engine 14 has been stopped using the first coordinated operation 100.

In a step 302 the vehicle 10 is stopped, in a step 304 the ESS system has stopped the engine 14, and in a step 306 the ACCS&G system is active. In a step 308, the ACC controller 20 determines if the brake pedal 25 is pressed. If the brake pedal 25 is pressed, then in a step 310 the ACCS&G system is deactivated and in a step 312 the engine 14 remains stopped.

If the brake pedal 25 is not pressed, then in a step 314 the ACC controller 20 determines if the ACCS&G system was deactivated by a means other than by pressing the brake pedal. For example, the ACCS&G system may be deactivated when an automatic transmission is not in drive or low gear, the driver applies an electric parking brake, the ACCS&G system times out (for example, after 3 minutes), or the driver deactivates the ACCS&G system with a command input (for example, pressing an “ON/OFF” button). If the ACCS&G system was not deactivated in the step 314 by a means other than pressing the brake pedal, then the step 314 is repeated. If the ACCS&G system was deactivated in the step 314 by a means other than pressing the brake pedal, then in a step 316 the ESS controller 18 will determine if at least one of the restart conditions has been met. If no restart condition has been met, then the step 316 is repeated. If at least one restart condition is satisfied, then in a step 318 the ESS controller 18 commands the powertrain controller 16 to start the engine 14. In a step 320 the engine is started.

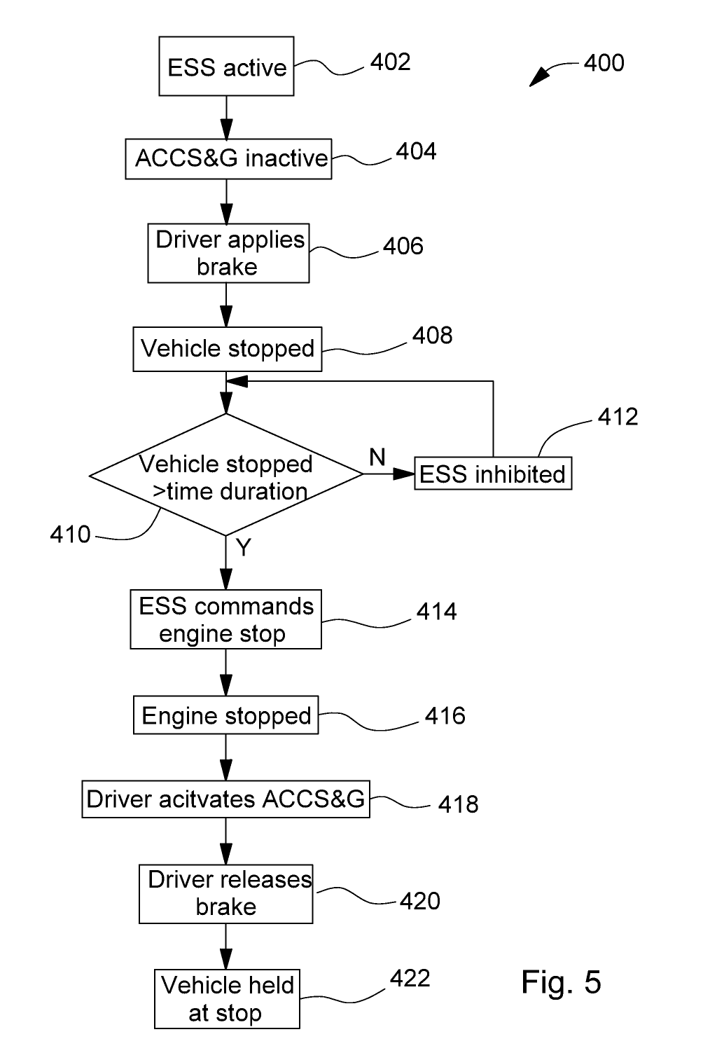

FIG. 5 will now be discussed with reference to FIG. 1. FIG. 5 is a flowchart illustrating a fourth coordinated operation 400 of the powertrain controller 16, the ESS controller 18, and the ACC controller 20 when the ACCS&G system is activated while the vehicle 10 has been stopped.

In a step 402 the ESS system is active, in a step 404 the ACCS&G system is inactive, in a step 406 the driver has applied the brake system 26, and in a step 408 the vehicle 10 has stopped. In a step 410, a time period is measured from when the vehicle 10 has stopped in the step 408. If the time period does not exceed a minimum duration, then the ESS system is inhibited from stopping the engine 14 in a step 412 and the step 410 is repeated. For example, the minimum duration may be 3 seconds. If the time period exceeds the minimum duration, then in a step 414 the ESS controller 18 commands the ACC controller 20 to stop the engine 14. In a step 416 the engine is stopped and in a step 418 the driver activates the ACCS&G system. In a step 420 the driver releases the brake pedal and in a step 422 the vehicle 10 is held stationary by the ACC controller 20.

While certain embodiments of the present invention have been described in detail, those familiar with the art to which this invention relates will recognize various alternative designs and embodiments for practicing the invention as defined by the following claims.

What is claimed is:

1. A method of controlling an engine comprising:
automatically bringing a vehicle propelled by the engine to a stop with a first system while a second system is active;
after a delay, stopping the engine of the stationary vehicle with the second system upon detection of a status of the first system;
restarting the stopped engine with the second system upon receipt of an input;
resuming propelling the vehicle with the first system using the restarted engine.

2. The method of claim 1 wherein the first system is an adaptive cruise control system with stop-and-go functionality and the second system is an engine start/stop system.

3. The method of claim 1 wherein the first system status received by the second system is that the first system is active, the first system is not requesting acceleration, and the first system is requesting braking.

4. The method of claim 1 comprising the additional step of holding the vehicle stationary with brakes of the vehicle prior to the second system stopping the engine.

5. The method of claim 1 wherein the input is from the first system.

6. The method of claim 1 wherein the input is from observing a position of a second vehicle relative to the vehicle.

7. The method of claim 1 wherein the input is from a driver of the vehicle.

8. The method of claim 1 wherein the input is from a condition of the vehicle.

9. The method of claim 1 wherein the first system brings the vehicle to a stop as a result of a second vehicle having stopped.

10. The method of claim 1 wherein, prior to the second system restarting the stopped engine, the first system is requesting acceleration.

11. The method of claim 1 wherein, prior to the second system restarting the stopped engine, the first system is not requesting braking to stop the vehicle.

12. The method of claim 1 wherein, prior to the second system restarting the stopped engine, the vehicle is not held stationary by brakes.

13. A method of controlling an engine comprising:
automatically bringing a vehicle propelled by the engine to a stop with a first system while a second system is active;
after a delay, stopping the engine of the stationary vehicle with the second system upon detection of a status of the first system;
detecting an input with the first system;
controlling the engine per the input with the second system.

14. The method of claim 13 wherein the first system is an adaptive cruise control system with stop and go functionality and the second system is an engine start/stop system.

15. The method of claim 13 wherein the first system status received by the second system is that the first system is active, the first system is not requesting acceleration, and the first system is requesting braking.

16. The method of claim 13 comprising the additional step of holding the vehicle stationary with brakes of the vehicle prior to the second system stopping the engine.

17. The method of claim 13 wherein the input is the driver pressing a brake pedal and the second system controlling the engine is the second system maintaining the engine stopped.

18. The method of claim 13 comprising the additional step of deactivating the first system when the driver presses the brake pedal.

19. The method of claim 13 wherein the input is other than the driver pressing a brake pedal and the second system controlling the engine is the second system restarting the engine.

20. The method of claim 19 wherein the input of other than the driver pressing the brake pedal is the first system directing the vehicle to be propelled.

21. The method of claim 13 wherein the first system brings the vehicle to a stop as a result of a second vehicle having stopped.

22. A method of controlling an engine comprising:
applying brakes to bring the vehicle to a stop while a first system is deactivated and a second system is activated, the vehicle being propelled by the engine;
after a delay, stopping the engine while the vehicle is stationary with the second system, and the first system remaining deactivated;
activating the first system while the vehicle is stationary, the engine stopped, and the brake activated;
releasing the brake while the first and second systems are activated and the engine stopped;
holding the vehicle stationary with the first system while the second system keeps the engine stopped.

23. The method of claim 22 wherein the first system is an adaptive cruise control system with stop-and-go functionality and the second system is an engine start/stop system.
